(19) United States
(12) Patent Application Publication
(10) Pub. No.: US 2007/0156415 A1
(43) Pub. Date: Jul. 5, 2007

(54) Changing delivery parameters in processing physical mail based on recipient's response to electronic notification

(75) Inventors: Thomas J. Foth, Trumbull, CT (US); Christopher J. Capelli, Chappaqua, NY (US); Charles R. Malandra JR., Monroe, CT (US); Angelo N. Chaclas, Southbury, CT (US); Frederick W. Ryan, Oxford, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Incorporated, Stamford, CT (US)

(21) Appl. No.: 11/321,120

(22) Filed: Dec. 29, 2005

(51) Int. Cl. G06Q 99/00

(52) U.S. Cl. 705/1

(57) ABSTRACT

A method for changing a delivery parameter of a mail piece intended to be delivered to an intended recipient, the method including receiving a first electronic file from a mailer regarding the mail piece; sending a first electronic communication to the intended recipient based upon the first electronic file; and receiving a second electronic communication based upon the first electronic communication. At least one of the delivery parameters of the mail piece are changed based upon the second electronic communication.

### BACKGROUND OF THE INVENTION

1. Field of the Invention

The present invention relates to physical mail and, more particularly, to changing a delivery parameter of a mail piece.

1. Brief Description of Prior Developments

In the past the production of mail (letters, postcards, parcels, catalogs, periodicals or the like) required a number of steps that must be coordinated in order for all the elements to come together and to meet the postal service pickup deadlines and the mailer's distribution schedules. The ability to track the production floor operations was essential to ensure that service level agreements are met. This in turn drove a need to provide a way for a customer owning high-speed mailing equipment to transfer customer data from their equipment based on real-time measurements and data collection. The data collected then needed to be transferred typically over a localized network or over the internet to a data processing system.

In the past, the data collection mechanisms were independent elements and storage mechanisms, which often implemented incompatible and disconnected data sources that could not be brought together to provide an overall view of the mail processing processes. Typically, data was provided using dedicated programs and work stations requiring constant presence by the user on the work floor.

It was often typical, that customers (e.g., mailers) of the postal carrier had multiple mailing sites but had no means to aggregate the mail piece data from each of those sites. Additionally, some customers maintained mixed vendor shops each having a mailing system using mailing data that may be incompatible relative to one another. Thus, the mailing data present at each of the aforementioned sites could not be aggregated between one another to enable a unified view of all the customers mailing operations.

Further, it has proven desirable that a user (mail sender or recipient) may often find it necessary to review the details on a particular mail piece that has passed through a mailing system (e.g., the USPS). One such objective to do so would be to track and trace a mail piece using minimal information.

To accomplish this objective, tracking and tracing mail pieces required a unique identifier for each mail piece in order for it to be recognized. However, the majority of mail pieces do not have such a unique identifier thus obviating tracking and tracing of such mail pieces. The United States Postal Service (USPS) did offer options (registered/certified mail) to provide individual mail tracking which was performed via optical scanning of the mail piece as it progressed through the USPS. However, these options were costly and only provided tracking at the beginning and end of the postal distribution cycle and relied on the cumbersome process of having to integrate with the scanning of the mail pieces to provide mail piece identification.

One prior art attempt to overcome the above deficiencies in tracking individual mail pieces was to assign a unique code to each mail piece (e.g., on mail pieces envelope). This approach is currently is use by various private carriers (e.g., FedEx, UPS, etc.). However, this approach is deficient in that the unique code is not shared amongst various postal carriers and requires significant investment by each private carrier to utilize it's own unique codes (e.g., requires infrastructures of scanners dedicated for it's unique code).

Additionally, there was no known method for identifying mail pieces and the contents of a mail piece prior to its processing by the carrier, such as the USPS (since optical scanning of the mail piece was required) so as to provide notification to an intended recipient regarding the impending mail piece delivery. If presented with this mail piece information, the recipient may then instruct the USPS to modify, change or cancel the impending delivery of the mail piece before the mail piece even begins processing by the USPS.

Accordingly, an object of the present invention is to provide a mail carrier (e.g., the USPS) the ability to provide electronic notification to an intended mail piece recipient regarding the impending mail piece delivery prior to the processing of the mail piece in the mail carrier system so that an intended mail piece recipient may instruct the USPS to modify, change or cancel the impending delivery of the mail piece before the mail piece begins processing by the USPS.

MAIL.DAT® is a standard embraced by a significant portion of the mail production industry and the USPS. MAIL.DAT® is a relational database of nineteen “connected” files describing characteristics that can exist within a mailing. MAIL.DAT files contain blank user fields which can be used by a mailer.

The USPS accepts MAIL.DAT® as an electronic representation of the mailing and as a replacement for the traditional hardcopy documentation.

The specification has continuously evolved since the first MAIL.DAT® format appeared in 1996. As with its predecessors, the current MAIL.DAT® specification is defined by circumstances as perceived at this time, but built-in flexibility makes it possible to readily adapt to new requirements, as they are recognized. The MAIL.DAT® Committee is constantly attending to the viability, currency, and accuracy of the MAIL.DAT® specification.

Confirm Tracking, PAVE Testing, ESP, Mail Acceptance, Mail Verification, Postage Payment, Destination Entry, Additional Entry, NSA'a, are but a few of the many mailing industry events that are supported, facilitated, optimized, and standardized through the use of MAIL.DAT®. MAIL.DAT® is ultimately used by the USPS for electronic acceptance, verification and payment via the USPS PostalOne!® program. A number of presort programs can generate MAIL.DAT® files either as a standard capability or as an option.

### SUMMARY OF THE INVENTION

In accordance with one aspect of the present invention, a method for changing a delivery parameter of a mail piece intended to be delivered to an intended recipient is provided, the method including receiving a first electronic file from a mailer regarding the mail piece; sending a first electronic communication to the intended recipient based upon the first electronic file; and receiving a second electronic communication based upon the first electronic communication. At least one of the delivery parameters of the mail piece are changed based upon the second electronic communication.

In accordance with another method of the invention, a method of preparing mail pieces to be mailed by a mailer is provided comprising preparing a list of intended recipients of the mail pieces; and changing the list of intended recipients based upon an electronic file from a service provider received by the mailer. The electronic file from the service provider comprises information from an electronic communication of an intended recipient on the list. Changing the list comprises deleting the intended recipient from the list.

In accordance with another aspect of the invention, a system for changing a delivery parameter of a mail piece intended to be delivered to an intended recipient is provided. The system comprises a system for receiving a first electronic file from a mailer regarding the mail piece; a system for sending a first electronic communication to the intended recipient regarding the mail piece based upon the first electronic file; a system for receiving a second electronic communication from the intended recipient based upon the first electronic communication; and a system for changing the delivery parameter of the mail piece based upon the second electronic communication.

In accordance with another aspect of the invention, a system for preparing mail pieces to be mailed by a mailer is provided. The system comprises a system for changing information in a list of intended recipients of the mail pieces based upon an electronic file from a service provider received by the mailer; and a system for addressing the mail pieces based upon the changed information in the list of intended recipients. The electronic file from the service provider comprises information from an electronic communication of an intended recipient on the list. The information changing system is adapted to delete the intended recipient from the list.

### BRIEF DESCRIPTION OF THE DRAWINGS

The foregoing aspects and other features of the present invention are explained in the following description, taken in connection with the accompanying drawings, wherein:

FIG. 1 is a schematic diagram of a mail system for delivering a mail piece between a mailer and an intended recipient;

FIG. 2 is a chart showing exemplary steps used in a method of the invention;

FIG. 3 is a block diagram showing exemplary systems used in the mail system shown in FIG. 1;

FIG. 4 is a diagram showing steps used in one exemplary method of the invention;

FIG. 5 is a block diagram showing exemplary systems used in the mail system shown in FIG. 1;

FIG. 6 is a diagram showing an example of an email communication to an intended recipient;

FIG. 7 is a diagram showing an example of a web site page which could be shown to the intended recipient;

FIG. 8 is an example of a display from a web site which could be shown to an intended recipient when the intended recipient desires to cancel delivery of a mail piece;

FIG. 9 is an example of a display from a web site which could be shown to an intended recipient when the intended recipient desires to forward a mail piece to a different address;

FIG. 10 is an example of a display from a web site which could be shown to an intended recipient when the intended recipient desires to pay a fee or charge;

FIG. 11 is an example of a display from a web site which could be shown to an intended recipient when the intended recipient desires view an image of a mail piece, such as a billing statement for example;

FIG. 12 is an example of a display from a web site which could be shown to an intended recipient when the intended recipient desires accelerate delivery of the mail piece;

FIG. 13 is an example of a display from a web site which could be shown to an intended recipient when the intended recipient showing a manifest of mail pieces intended to be delivered to the intended recipient;

FIG. 14 is a flow chart showing steps in an exemplary method of the invention;

FIG. 15 is a flow chart showing steps in another exemplary method of the invention;

FIG. 16 is a block diagram shown components of one exemplary embodiment of the invention;

FIG. 17 is a block diagram shown components of another exemplary embodiment of the invention;

FIG. 18 is a flow chart showing steps in another exemplary method of the invention;

FIG. 19 is a flow chart showing steps in another exemplary method of the invention;

FIG. 20 is a block diagram shown components of another exemplary embodiment of the invention;

FIG. 21 is a block diagram shown components of another exemplary embodiment of the invention;

FIG. 22 is a flow chart showing steps in another exemplary method of the invention;

FIG. 23 is a flow chart showing steps in another exemplary method of the invention;

FIG. 24 is a block diagram shown components of another exemplary embodiment of the invention;

FIG. 25 is a flow chart showing steps in another exemplary method of the invention;

FIG. 26 is a flow chart showing steps in another exemplary method of the invention; and

FIG. 27 is a block diagram shown components of another exemplary embodiment of the invention.

### DETAILED DESCRIPTION OF THE PREFERRED EMBODIMENTS

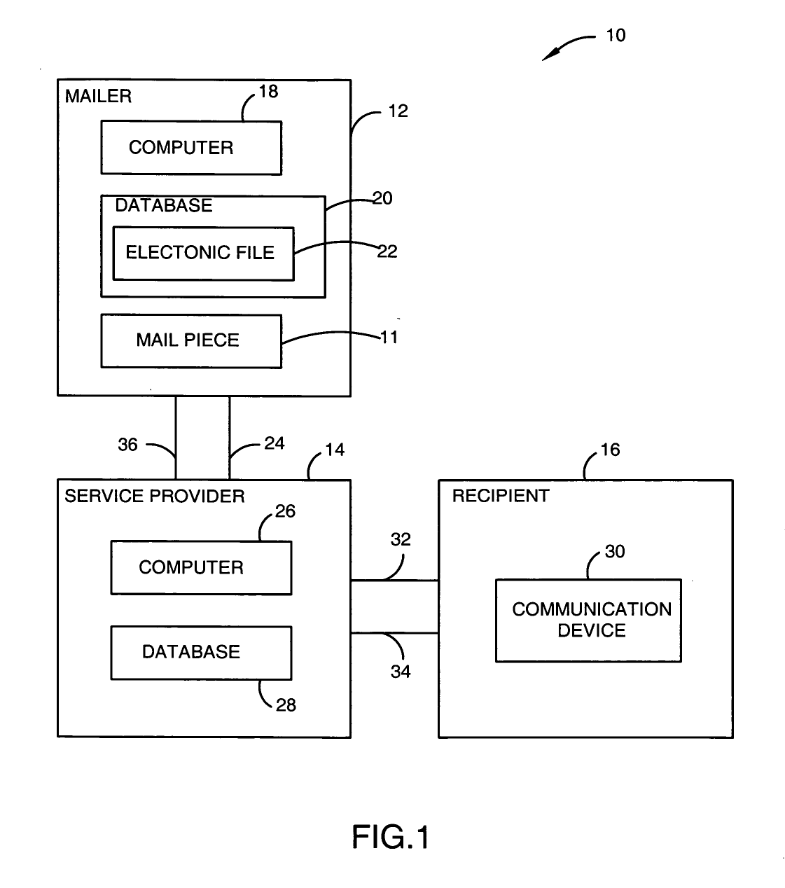

Referring to FIG. 1, there is shown a diagram of a mail system 10 incorporating features of the invention. Although the invention will be described with reference to the exemplary embodiments shown in the drawings, it should be understood that the invention can be embodied in many alternate forms of embodiments. In addition, any suitable type of elements or combination of elements could be used.

The mail system 10 generally comprises a mailer 12, a service provider 14 and a recipient 16. Although FIG. 1 shows only one recipient 16, it is to be understood that features of the invention are preferably used with multiple intended recipients. The invention generally relates to use of advance notification of a mail piece and/or contents of a mail piece similar to the systems and methods described in U.S. patent application Ser. Nos. 11/027,176 and 11/027,175, both filed Dec. 29, 2004 which are hereby incorporated by reference in their entireties.

The mailer 12 can comprise a computer 18 and a database 20. The mailer 12 could comprise, but is not limited to, a large volume mailer producing large volumes of mail pieces 11 that are distributed to intended recipients, such as recipient 16, via the service provider 14. Typically, mailer 12 produces mail pieces 11 relating to a high volume mail run (e.g., a utility company's monthly billing statements), which mail run is then physically delivered to the service provider 14 for subsequent delivery to each respective intended recipient. Each mail piece contained in a mail run preferably includes a POSTNET barcode and may also include a Planet Code barcode and/or any other suitable indicium.

To provide enhanced delivery of its generated mail pieces 11, the mailer 12 preferably provides to the service provider 14 an electronic file 22, such as a MAIL.DAT® file for example. The electronic file 22 preferably includes specific information relating to each mail piece 11 delivered to the service provider 14 from the mailer 12 or intended to be delivered to the service provider 14 from the mailer 12. Although a preferred embodiment is described using a MAIL.DAT® file as the electronic file delivered from the mailer to the service provider, the electronic file might not be a MAIL.DAT® file. The electronic file could comprise any suitable electronic file having information regarding the mail pieces.

A MAIL.DAT® file is a current mailing industry standard for transferring information about mail pieces from one mailing program (e.g., the mailer 12 in the embodiment of FIG. 1) to another mailing program (e.g., the service provider 14 in the embodiment of FIG. 1). The MAIL.DAT® file is preferably used by the service provider 14 for any variety of purposes, including: electronic acceptance, verification and payment purposes; or any combination thereof. Amongst other information, the MAIL.DAT® file preferably includes a respective record containing the POSTNET barcode (or other delivery indicator) and addressee name for each mail piece provided in a mail run and recorded in the corresponding MAIL.DAT® file. Preferably, each mail piece contained in a mail run has an electronic record created for it in the MAIL.DAT® file. As noted above, a MAIL.DAT file has blank user fields which, heretofore, have not had an assigned purpose. The invention can use these blank fields if desired.

The electronic file (e.g., the MAIL.DAT® file) 22 is stored in the database 20. The computer 18 is adapted to use the information stored in the electronic file to generate the mail pieces. Alternately (and most typically) the preproduction of mail pieces generates the MAIL.DAT® file. The computer 18 is also adapted to communicate the electronic file 22 to the service provider 14 via the link 24. The link could comprise any suitable type of link for transferring information including, for example, an internet connection, a telephone line connection, or a physical delivery of the electronic file 22 on a recorded medium such as a diskette, tape or CD-ROM. These are only some examples. Any suitable link could be provided.

The service provider 14 could comprise any suitable type of mail service provider including, for example, a postal service (e.g., USPS, Canada Post, Deutsche Post), a carrier (e.g., FEDERAL EXPRESS, DHL, or UNITED PARCEL SERVICE (UPS)), a company mailroom, a government mailroom, etc. The service provider could be comprised of multiple entities including one or more companies which are not mail service providers. For example, the service provider 14 could comprise the USPS and a subcontractor hired by the USPS. The service provider could comprise two or more postal services, such as the USPS and the Canadian postal service for example. The service provider 14 can function as a mail delivery service provider for delivering mail pieces, received from the mailer 12, to the recipients; including recipient 16.

Rather than a subcontractor, the invention can use a third party which is not a subcontractor of the postal service or mail service provider. In one scenario a third party would work independent of the mail service provider, yet still receive information from the mail service provider. For example:
a. a mailer could send the third party their MAIL.DAT® file;
b. the third party could pre-notify via email the intended recipients;
c. the recipients could respond to the third party;
d. the third party could notify the mailer of any requested/required changes; and
e. the mailer could makes changes and send the mail via the service provider or the mail service provider.
   However, not all of the services can be accomplished in this way. Some service will need to be accomplished other than through a third party, such as services which must be accomplished by the mail service provider (e.g., redirection by the USPS, expediting delivery by the USPS, etc.)

Upon receipt of the mail pieces from the mailer 12 by the service provider 14, each mail piece can be scanned to obtain the delivery address for the mail piece. Scanning can detect the POSTNET barcode on the mail pieces. If a POSTNET barcode is not provided on the mail piece by the mailer 12, the service provider 14 can determine, preferably through optical character recognition techniques, a POSTNET barcode for the mail piece. The service provider 14 can then print the determined POSTNET barcode on the mail piece. Once the POSTNET barcode for a mail piece is recognized by the service provider, the mail piece is routed through the proper delivery channels within the service provider to deliver the mail pieces to their respective intended recipient as indicated by link 32. Rather than a POSTNET code, any suitable delivery addressing system could be used.

The service provider 14 preferably comprises at least one computer 26 and at least one database 28. The database 28 is adapted to store the electronic file 22. The computer is adapted to process mail pieces based upon information in the electronic file. The electronic file 22 could have a field comprising an email address or other electrical/electronic communication address of the intended recipient 16. The intended recipient 16 can comprise a communication device 30 to receive an electrical/electronic communication, such as an email for example. The intended recipient 16 could be an individual or an entity. The communication device 30 can comprise any suitable device for receiving information electronically including a computer, a personal digital assistant (PDA), a pager, a mobile telephone, a television cable or satellite box, or any type of device adapted for wireless or wired communication including a gaming device. Rather than an email address for communication, the electronic communication address field could comprise an IP address or any other suitable type of electronic communication address. Alternatively, such as when the service provider has the electrical or electronic communication address of the intended recipient 16, such as a telephone number or email address of the intended recipient 16 for example, the electronic file 22 need not comprise a field with the electronic/electrical communication address of the intended recipient 16.

As noted above, in a first embodiment the electronic file 22 could comprise electronic/electrical communication address of the intended recipient 16. Alternatively, or additionally, in a second embodiment the service provider 14 could have a file in the database 28 comprising the electronic/electrical communication address of the intended recipient 16. When the service provider 14 receives the electronic file 22 from the mailer 12, the service provider can use the electronic communication address field in the electronic file 22 (and/or the file in the database 28 comprising the electronic/electrical communication address of the intended recipient 16) and the link 34 to send a message or first communication to the intended recipient 16. This first communication is generally in regard to the mail piece sent by the mailer 12, or intended to be sent by the mailer 12 (the file can be sent by the mailer to service provider before mail is produced or after the mail is produced but before the mail is mailed), to the communication device 30 of the intended recipient 16.

The link 34 could comprise any suitable type of link, which can be wired or wireless, for example, including, a telephone connection, an Internet connection, a cable connection, a satellite connection, etc. The first communication could comprise any suitable type of electrical or electronic message including, for example, an email message, a telephone message, a text message, a pop-up window, an instant message, etc. The first communication could be tied to the name of an addressee and/or a street address, for example. For example, if the mail piece is addressed to the Head of Household or Occupant, the first communication could then be tied to a street address rather than an address. The service provider can have an file with email addresses (or other communication address(es)) for street addresses and/or individual addressees. This can be provided by the addressees and/or the mailer(s).

The content of the first communication preferably comprises information regarding the mail piece mailed by the mailer, or intended to be mailed by the mailer, which is addressed to the intended recipient 16. The first communication could comprise additional information. In one type of embodiment, the first communication might only comprise information regarding the mail piece, for informational purposes, without giving the intended recipient an opportunity to response directly from that first communication. However, in a preferred embodiment, the first communication comprises a link or other application initiator to allow the intended recipient to respond to the first communication or otherwise take action regarding the first communication. In one type of embodiment, the response initiator could comprise an email response initiator allowing the recipient 16 to send a response email to the service provider 14, and/or the mailer 12, and/or a third party (not shown). In another type of embodiment, the response initiator could comprise a Uniform Resource Locator (URL) internet address that is provided to the recipient in the first communication. Preferably, the URL, when provided to a recipient's communication device 30, directs the recipient 16 to a web page on the internet that may or may not be related to the contents of the mail piece which is to be delivered to the recipient 16.

Examples of such web pages could include, for example: a preview of the mail piece, related (or unrelated) advertising and marketing material, a survey, invitation to electronic billing and payment services, a request to modify or cancel delivery-of mail piece, etc. It is to be appreciated that this URL may be the same or generic for each mail piece contained in the mail run, or it may be customized for each respective recipient in the mail run. In the event the URL is customized for each respective recipient 16, then each aforesaid record contained in the mail run may preferably include a URL customized in some capacity for the respective mail piece recipient for that record. The URL could be run or hosted by the service provider 14, the mailer 12, and/or a third party (not shown).

The web site of the URL preferably allows the recipient to send a second communication in response to the first communication. The second communication could be sent via the link 34 or another link (not shown) to the service provider 14, and/or the mailer 12, and/or a third party (not shown). The second communication could include, for example, a telephone connection (wired or wireless), an Internet connection, a cable connection, a satellite connection, etc. The second communication could comprise any suitable type of electrical or electronic message including, for example, an email message, a telephone message (touch tone or voice), a Short Message Service (SMS), an instant message, etc. Rather than through a URL link to a web site, the second communication could be sent by any suitable means, such an email as noted above or by telephone for example. The URL web site could be hosted by the mailer, the service provider, or a third party. Preferably, the MAIL.DAT® file would have a field containing the URL information. The service provider could modify the URL information such that the service provider acts as a pass-through for the Internet connection. The URL could be recipient specific. The service provider could be adapted to inform the mailer that the recipient looked at the web site of the URL. Alternatively, the viewing of the URL web site could be anonymous. Anonymity could be a feature selected by the recipient.

One feature of an embodiment of the invention is a system and method for sending recipient created information (in other words, information created by the intended recipient 16) to the service provider 14 and/or the mailer 12. When the recipient created information is sent to the mailer, in a preferred embodiment the recipient created information is sent from the service provider 14 to the mailer 12. However, in an alternate embodiment the recipient created information could be sent to the mailer directly from the intended recipient 16 or via a third party (not shown). The recipient created information could be sent via the second communication or by means of the intended recipient clicking on a URL link or hyperlink or other link in the first communication.

The content of the second communication could comprise any suitable type of content including, for example, instructions regarding delivery of the mail piece. The instructions could comprise, for example, an instruction not to deliver the mail piece, an instruction to deliver the mail piece to a different address, an instruction to accelerate delivery of the mail piece, an instruction to delay delivery of the mail piece, an instruction to change at least one delivery parameter (such as requiring a signature for receipt). The content could have nothing to do with delivery, such as the content comprising information regarding an electronic bill payment or an order for advertised goods. These are only some examples.

Based upon content of the second communication or a reaction by the recipient 16 to the first communication, the mailer 12 could take such actions as change content in the mail piece, or not mail the mail piece, or mail the mail piece to a different address, or mail the mail piece to a different addressee for example. Based upon content of the second communication or a reaction by the recipient 16 to the first communication, the mail service provider could not deliver the mail piece, redirect the mail piece to another address, redirect the mail piece to another addressee (specified by the recipient 16 or the mailer 12), accelerate delivery to the recipient 16, or delay or hold delivery for the recipient 16 for example. In the event the service provider 14 is a party other than a Post/carrier, the service provider 14 would direct the Post/carrier accordingly. Thus, feedback from the intended recipient can alter physical handling or processing of the mail piece before the intended recipient receives the mail piece, and perhaps before the mail piece is mailed or created by the mailer 12. As another example, if the mail piece is a check, the invention could allow for the mailer not to mail the check and, instead, perform a direct deposit of the funds into bank account information supplied by the intended recipient in response to the first communication. Special delivery could be subject matter dependent. In other words, the subject matter of the mail piece could control whether or not there is a special delivery option available.

The service provider 14 can act on information in the second communication from the recipient 16. The service provider 14 can also communicate the information in the second communication to the mailer 12. In a preferred embodiment, the service provider 14 combines information from the second communication with information from the electronic file 22 and sends or delivers a second electronic file to the mailer comprising this combined information, such as via link 36. Link 36 might be the same as link 24. The mailer 12 can use the information in the second electronic file to update its files for the future or perhaps change its mailing if received before the mail run is produced and mailed. In one scenario the response may go directly to the mailer. In that case, the mailer could then inform the service provider how the mail should be handled and/or can update the MAIL.DAT® file before it is sent to the service provider.

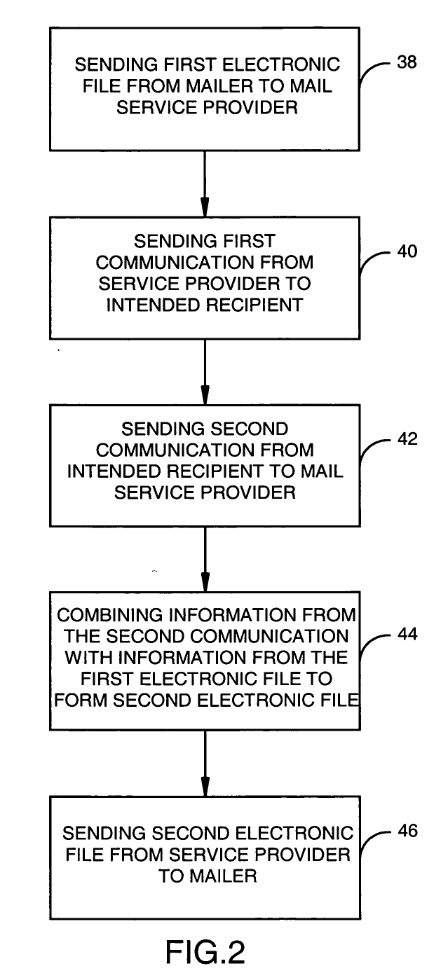

Referring to FIG. 2, one method of the invention is shown in a flow chart. This flow chart is merely exemplary. Additional steps or less steps could be used. As shown by block 38 the first electronic file is sent by the mailer to the mail service provider. As shown by block 40 the service provider sends a first communication to the intended recipient. Although the first communication could be sent to the intended recipient 16 directly from the mailer 12 or a third party (not shown), in a preferred embodiment the first communication is sent by the service provider such that only the service provider needs to have the intended recipient's electrical/electronic delivery address. The service provider can, thus, function as a filter to limit first communications to the intended recipient. The service provider can also authenticate a mailer and, thus, authenticate to the intended recipient that information in the first communication is from the mailer and not from an unauthorized third party. This can prevent spoofing (spamming). The intended recipient only needs to have one electronic certificate relating to the service provider to authenticate the first communication. The service provider could then be responsible for authenticating the delivery of the file 22 from the mailer 12. Use of an electronic certificate is not the only way for the recipient to authenticate the service provider. The recipient may authenticate the service provider through any number of means. However, standard certificate based communication (e.g., PGP, SSL, digitally signed email, etc.) is a preferred embodiment.

The intended recipient can send a second communication to the mail service provider, or a service provider, as indicated by block 42. As shown by block 44 the service provider can combine information from the second communication with information from the first communication to form a second electronic file. The second electronic file can then be sent to the mailer as shown in block 46. With this method, the service provider 14 can provide the mailer 12 with feedback from the intended recipient 16 before the mail piece is physically delivered to the intended recipient. This feedback could be received by the mailer before the mail piece is mailed, or alternatively, before the mail piece is created. This would allow the mailer to change its intended mail run, change configuration of the mail piece, or change mailing of the mail piece. In one example, the service provider's email to the recipient could provide a mechanism for the recipient to contact the mailer directly using information from the file sent by the mailer to the service provider and/or information provided by the service provider.

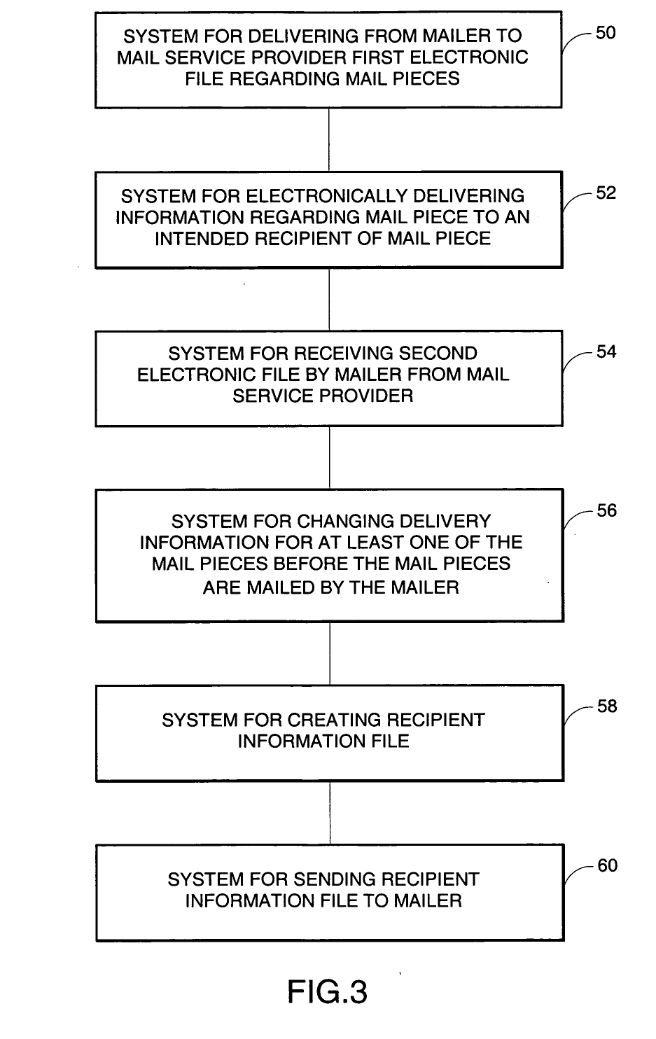

Referring also to FIG. 3, with the invention a system for providing feedback information to a mailer can be provided and a system for changing delivery information for mail pieces can be provided. FIG. 3 shows various systems which can be used to perform the method described in FIG. 2. Some of the systems could share components. The system for providing feedback information to a mailer can include a system 52 for electronically delivering information regarding a mail piece to an intended recipient of the mail piece, a system 58 for creating a recipient information file, and a system 60 for sending the recipient information file to the mailer.

The electronic delivery system 52 can include the computer 26, database 28 and link 32 for sending information from the file 22, received by the service provider 14, to the intended recipient 16 via the communication device 30. The creating system 58 can comprise the computer 26, database 28 and information from how the intended recipient reacted to the receipt of the first communication. That reaction could be sending a second communication by the intended recipient to the service provider, clicking on a link in the first communication, or perhaps no action by the recipient 16 for example. It could also be an email, a phone call, a fax or other form of communication.

The second communication could comprise, for example, an instruction not to deliver the mail piece, a request by the mailer to change the content of the mail piece, an instruction to change a delivery parameter of method of delivery of the mail piece by the service provider. These are only some examples. Clicking on a link in the first communication could be recorded by the service provider for the recipient information file. The link could also be routed through the service provider for security purposes and/or further monitoring of the recipient's reaction and recording in the recipient information file. The system 60 for sending the recipient information file to the mailer is adapted to send the mailer 12 feedback information from the recipient 16; preferably only through the service provider or the mail service provider. The system 60 can preferably correlate the recipient information file with the first electronic file 22 sent by the mailer (e.g., the MAIL.DAT® file).

The system for changing delivery information for mail pieces can comprise a system 50 for delivering from a mailer to a mail service provider a first electronic file regarding the mail pieces; a system 54 for receiving a second electronic file by the mailer from the mail service provider or a service provider; and a system 56 for changing the delivery information for at least one of the mail pieces before the mail pieces are mailed by the mailer based upon the second electronic file received by the mailer. The second electronic file can comprise at least some information from the first electronic file and additional information.

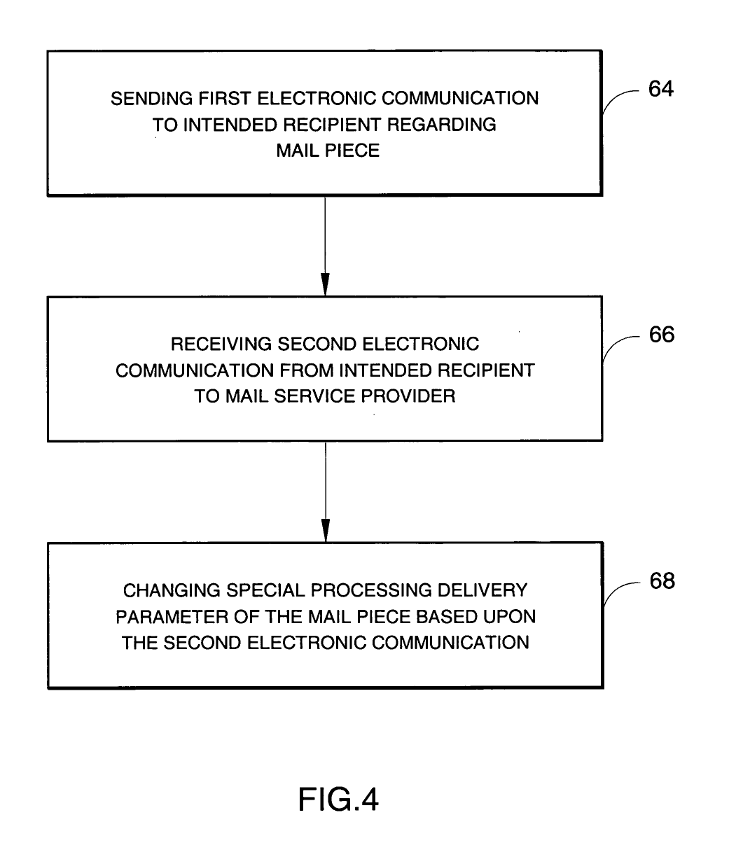

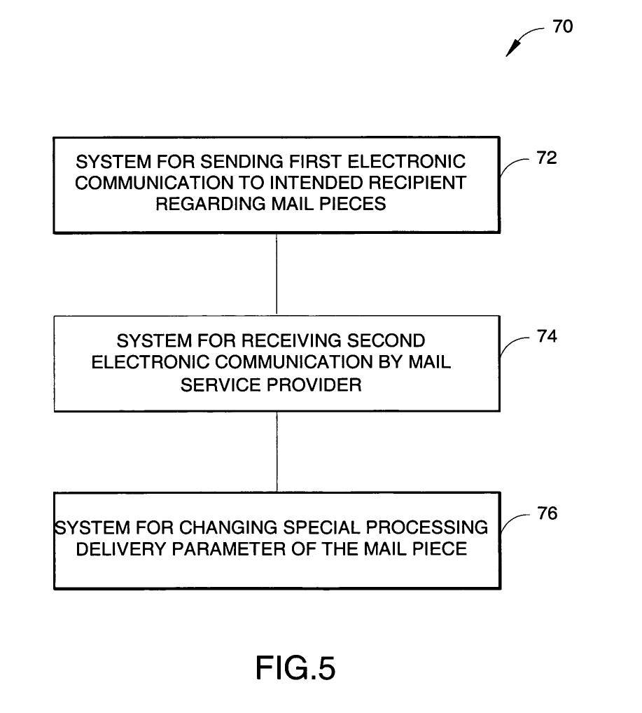

As noted above, the invention can be used for changing delivery parameters of the mail piece. Referring also to FIG. 4, the invention can comprise a method for changing a special processing delivery parameter (such as certified mail return receipt, overnight delivery) of a mail piece intended to be delivered to an intended recipient. The method can comprise sending a first electronic communication to the intended recipient regarding the mail piece as indicated by block 64; receiving a second electronic communication from the intended recipient to a mail service provider or a service provider based upon the first electronic communication as indicated by block 66; and changing the special processing delivery parameter of the mail piece based upon the second electronic communication from the intended recipient as indicated by block 68. The communications could be between the service provider and the recipient, or between the mailer and recipient (facilitated by the service provider). One path could comprise the first communication going through the service provider, but the second communication not going through the service provider. Referring also to FIG. 5, the system 70 for changing a special processing delivery parameter of a mail piece intended to be delivered to an intended recipient can comprise a system 72 for sending a first electronic communication to the intended recipient regarding the mail piece; a system 74 for receiving a second electronic communication by a mail service provider or a service provider from the intended recipient based upon the first electronic communication; and a system 76 for changing the special processing delivery parameter of the mail piece based upon the second electronic communication from the intended recipient.

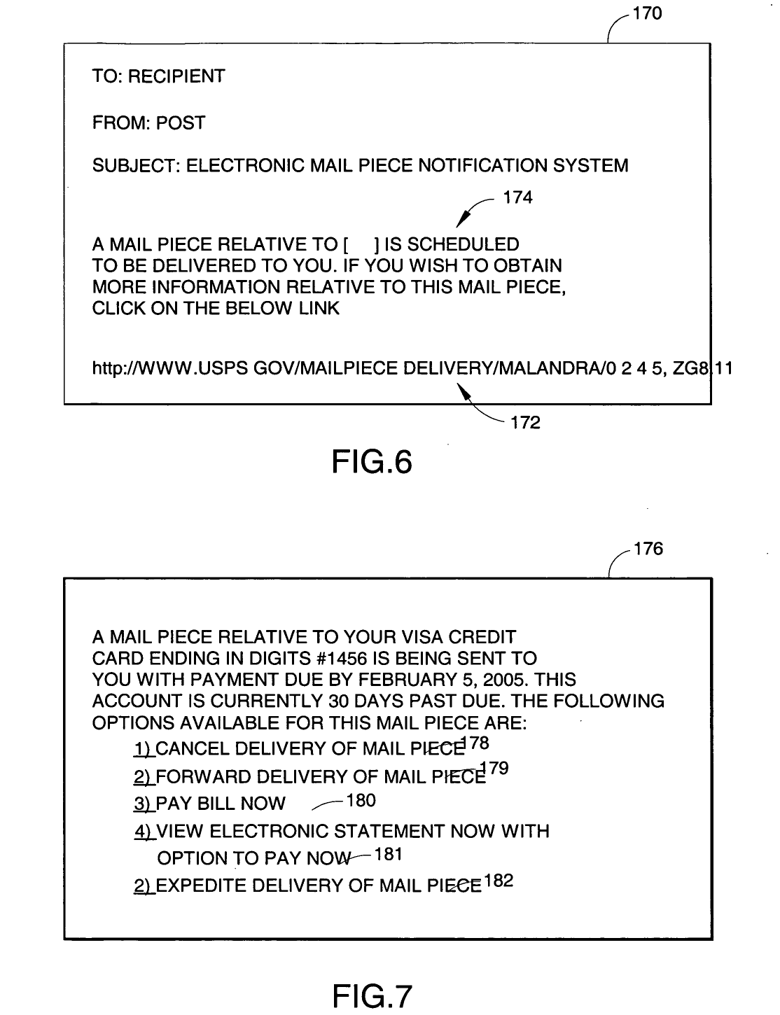

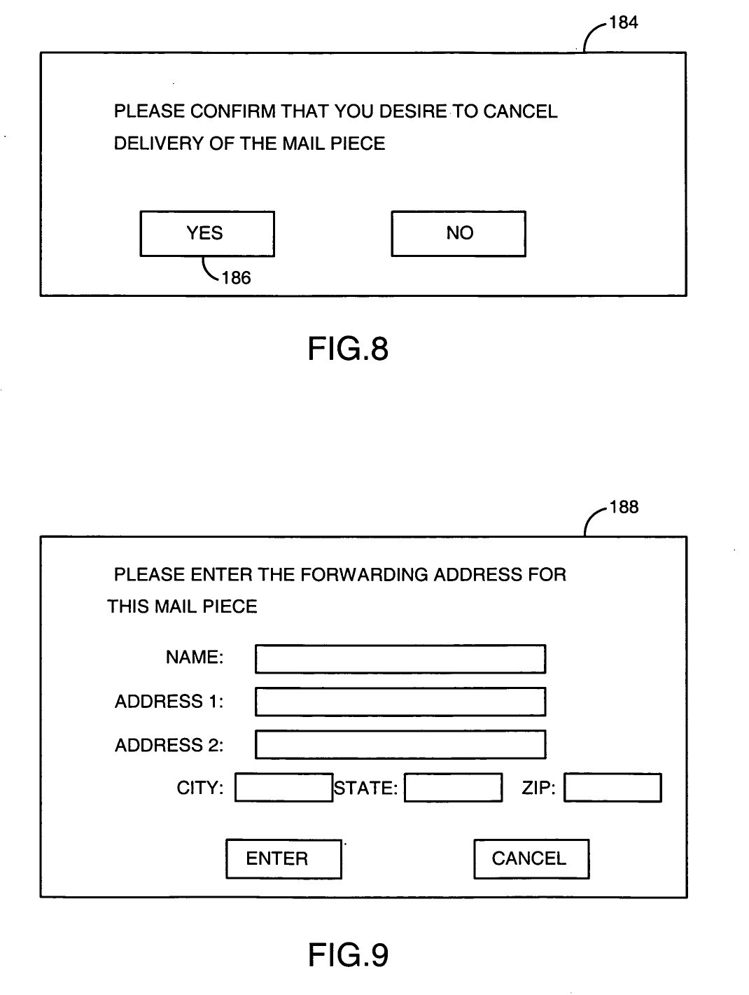

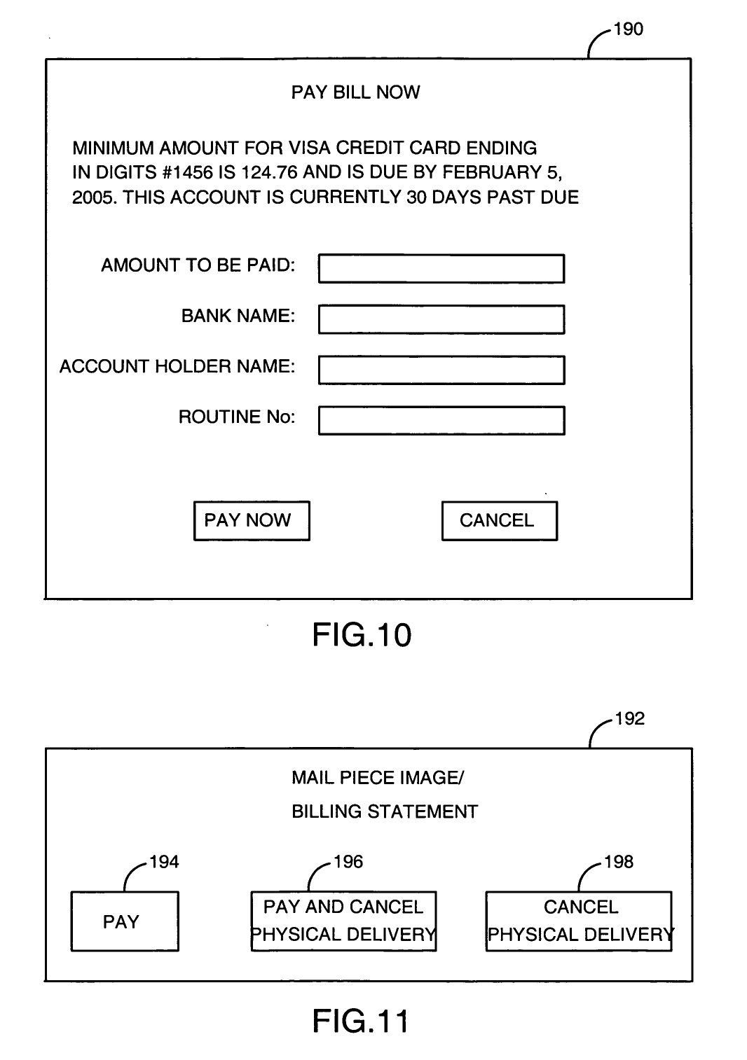

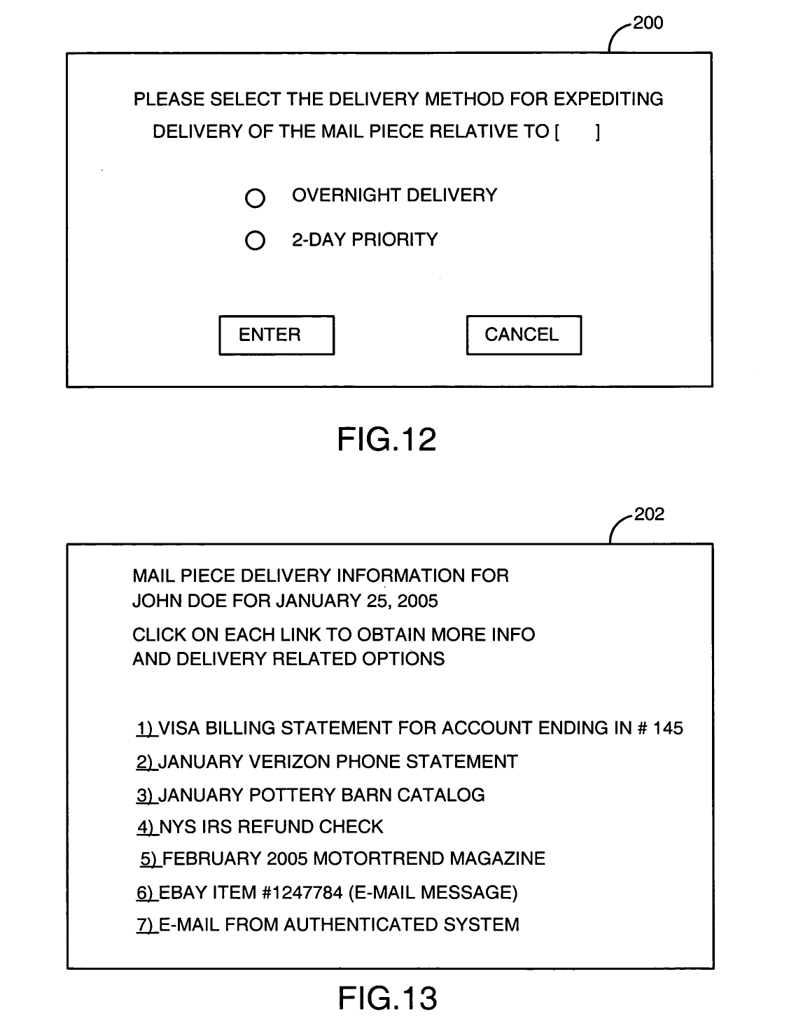

Referring now to FIGS. 7-14, one implementation of the invention as viewed on a display of the communication device 30 of the intended recipient 16 will be described. FIG. 6 shows an example of an email 170 which could be sent to the intended recipient 16. The email contains information 174 regarding a mail piece intended to be delivered to the intended recipient 16 and a link 172 which can be selected by the intended recipient. The service provider can add information to that from the mailer (e.g., route the mail piece is/has/might take, most likely delivery date, etc.). FIG. 7 shows an example of a web page 176 which is displayed after clicking on the link 172, such as a web page hosted by the mail service provider 14 for example. When the web page 176 is hosted by the mail service provider, the mail piece specific information on the web page 176, namely “#1456”, “Feb. 5, 2005” and “30 Days Past Due”, could be information received by the service provider from the mailer in the MAIL.DAT® file. In the web page shown the intended recipient has the option of selecting tasks 178-182 for canceling delivery of the mail piece, forwarding delivery of the mail piece, paying the bill now, viewing an electronic statement now with an option to pay now, and expediting delivery of the mail piece, respectively. Simply the fact that the recipient clicked on the link could be reported to the mailer. If option task 1 178 is selected, then a web page 184 such as shown in FIG. 8 could be displayed. If the intended recipient 16 selects the YES button 186 the mail service provider can cancel delivery of the mail piece and also perhaps send a notice to the mailer regarding the cancellation. If option task 2 179 is selected, then a web page 188 such as shown in FIG. 9 could be displayed. Provision could be made for automatically filling in the fields based upon a previously stored or used address. The information for automatically filling in the fields could be stored in the recipient's computer or in the service provider's computer. For the mail piece forwarding screen shown in FIG. 9, the input information could then be used to forward a mail piece to a new address or re-address a mail piece before it is mailed (and perhaps before the mail piece is created). The forwarding address could be sent directly to the mail service provider or the mailer for example. If option task 3 180 is selected, then a web page 190 such as shown in FIG. 10 could be displayed such as hosted by the service provider, or the mailer or a third party. Depending upon how a mailer sets it up, payments could occur using methods of payment known to be used with email or Internet payments, such as a credit card payment, and electronic funds transfer (EFT), a subscriber service payment, etc. If option task 4 181 is selected, then a web page 192 such as shown in FIG. 11 could be displayed such as hosted by the service provider, or the mailer or a third party. If button 194 is selected, the intended recipient could be redirected to web page 190 shown in FIG. 10. If button 196 is selected, the intended recipient could be redirected to web page 190 shown in FIG. 10 and then to web page 184 shown in FIG. 8. If button 198 is selected, the intended recipient could be redirected to web page 184 shown in FIG. 8. Referring back to FIG. 7, if option task 5 182 is selected, then a web page 200 such as shown in FIG. 12 could be displayed by the service provider. This could allow accelerated delivery of the mail piece by the service provider. Payment for the additional service could be paid by the recipient, such as by use of a charge account, credit card, EFT for example.

Alternatively, the recipient can instruct the mail service provider (or mailer) to image mail pieces that are intended to be physically delivered so the recipient can receive images of contents of the mail piece. These images can be transmitted to a recipient in a number of ways (email, internet (user web page), pop-up, etc). In addition to a recipient receiving the mailpiece on a same day basis, the recipient is now able to receive his mail pieces when reliance on physical delivery is not accommodating (e.g., traveling salesperson). Imaging may be necessary when access to an electronic file (mail file) containing the images is not convenient, and the mail files do not have all the images enclosed in the mail piece (e.g., inserts, checks, handwritten notes, etc). Furthermore, imaging can be done quickly with present high speed scanners and the mail service provider can recover a fee for this value added service.

FIG. 13 shows a web page 202 which could be displayed to the intended recipient by the mail service provider as a web page which has a manifest of mail pieces listed and the ability to select and take action (or at least view information) regarding at least one of the mail pieces. The manifest list on the web page provides an easy to understand and view list of mail pieces intended to be delivered to the recipient before the mail pieces are actually delivered. This gives the recipient advance notice of the mail pieces yet to be delivered. However, a manifest of mail pieces might not be used.

With the invention, content of a mail piece can be changed by the mailer 12 before creation of the mail piece. More specifically, if the mailer 12 sends the first electronic file 22 to the service provider 14 before a mail run (i.e., before the mail pieces are assembled into their final form), and the mailer also receives the second electronic file with the intended recipient's added information before the mail run, then the mailer 12 can change the content or the mail piece or perhaps not send the mail piece to the intended recipient. For example, the mailer 12 could add an insert to the mail piece based upon the intended recipient's reaction to information in the first electronic file 22, or replace an insert with a different insert, or print different information in or on the mail piece. As another example, based upon the reaction of the intended recipient as provided in feedback to the mailer from the mail service provider or a service provider, the mailer could decide not to mail the mail piece to the intended recipient and, instead, mail the mail piece to a different intended recipient. This type of system could allow a mailer a more efficient and effective delivery of information in the mail piece for better product or service marketing. There will be less likelihood of delivery of the mail piece to an uninterested intended recipient and a greater likelihood of delivery of the mail piece to an interested recipient. This can save costs for the mailer and increase profits while reducing “junk” mail delivery to the uninterested recipients. The system can help the intended recipient filter and/or configure content of a mail piece to be delivered before the mail piece is created. The system can alternatively or additionally help the intended recipient filter delivery of mail pieces before and/or after they are created, but before they are delivered. Thus, the invention can be used as a form of “spam” filter for physical mail pieces adaptable for individuals and well as facilitating reaction to temporal variations (short term or long term, e.g., seasonal relocation of a recipient, short term relocation based upon a natural disaster, etc.). This physical mail piece type of spam filter or junk mail filter can be set up without using a sender/mailer email address to filter. Instead, the filter can be set to an addressee's name and/or mailing address.

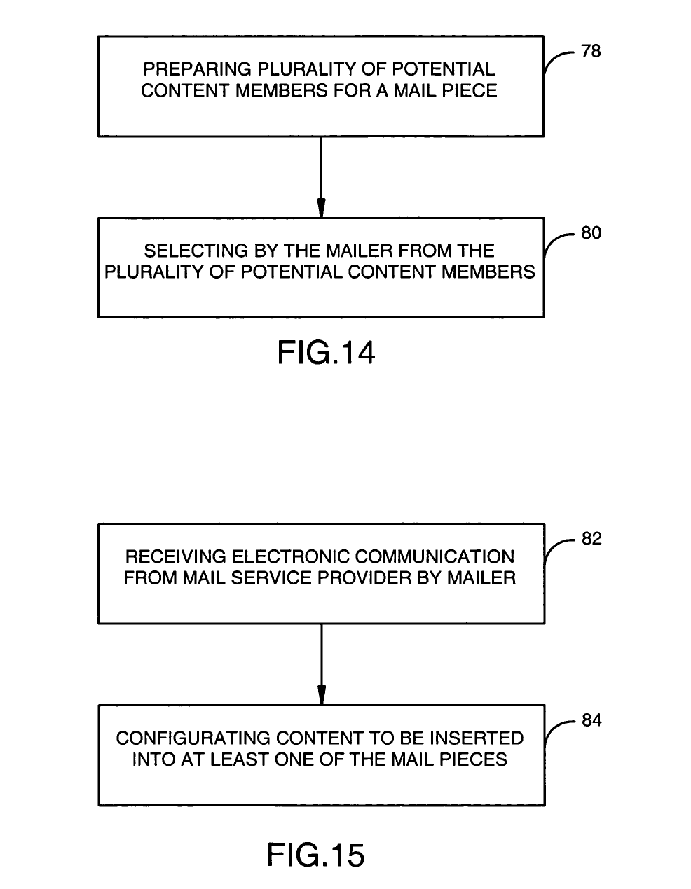

Referring also to FIG. 14, a method of preparing mail pieces to be mailed by a mailer can be provided comprising preparing a plurality of potential content members for a mail piece as indicated by block 78; and selecting by the mailer from the plurality of potential content members individual ones of the content members for creation of the mail pieces based upon an electronic communication from a mail service provider or a service provider as indicated by block 80. The content members can comprise mail piece inserts, for example, such as brochures or coupons. A mail assembly machine, such as the APS Series™ Inserters by Pitney Bowes Inc. of Stamford, Conn., at the mailer can select a predetermined one(s) of the inserts for insertion into different mail pieces to different intended recipients based upon feedback from the intended recipients and/or the service provider. Thus, insert A might be included with the mail piece to intended recipient A and inserts A and B might be included with the mail piece to intended recipient B based upon feedback from one or both of the intended recipients A, B.

Referring also to FIG. 15, the method can comprise receiving an electronic communication from a mail service provider or a service provider by the mailer as indicated by block 82, wherein the electronic communication comprises information from at least one intended recipient of the mail pieces; and configuring 84 content to be inserted into at least one of the mail pieces based upon the electronic communication received from the mail service provider or the service provider.

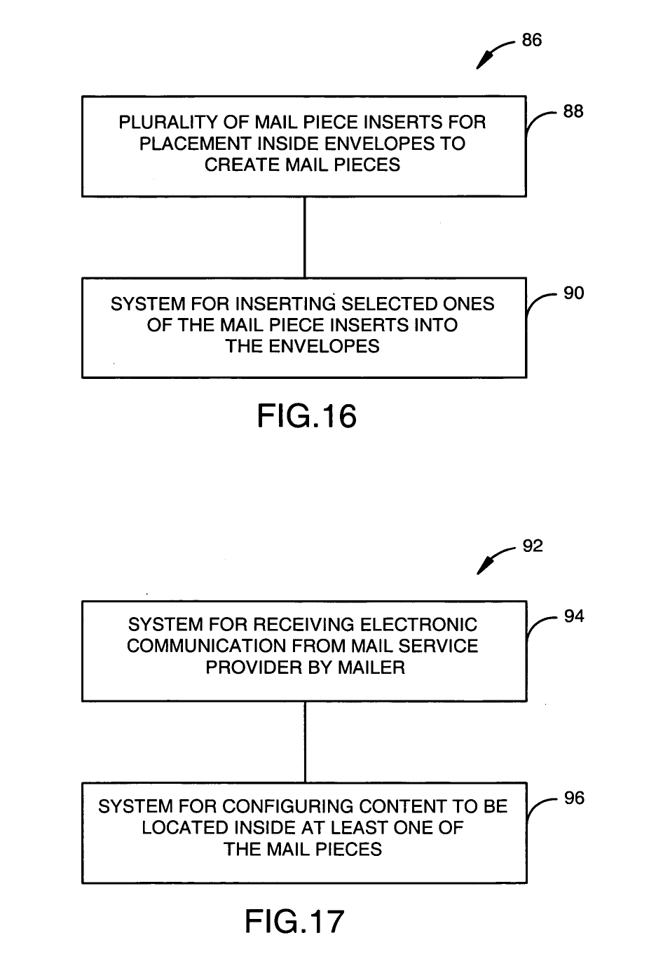

Referring also to FIG. 16, a system 86 for preparing mail pieces to be mailed by a mailer can be provided comprising a plurality of mail piece inserts 88 for placement inside envelopes to create the mail pieces; and a system 90 for inserting selected subsets or ones of the mail piece inserts into the envelopes. At least two of the envelopes can contain different ones of the mail piece inserts based, at least partially, upon an electronic communication from a mail service provider or a service provider. However, an entire address list could have the same inserts. Therefore, the insert machine could be configured to have the same insert(s) in all the mail pieces of a mail run. Referring also to FIG. 17, a system 92 for preparing mail pieces to be mailed by a mailer can be provided comprising a system 94 for receiving an electronic communication from a service provider, such as a mail service provider for example, by the mailer, wherein the electronic communication comprises information from at least one intended recipient of the mail pieces; and a system 96 for configuring content to be located inside at least one of the mail pieces based, at least partially, upon the electronic communication received from the service provider, such as a mail service provider.

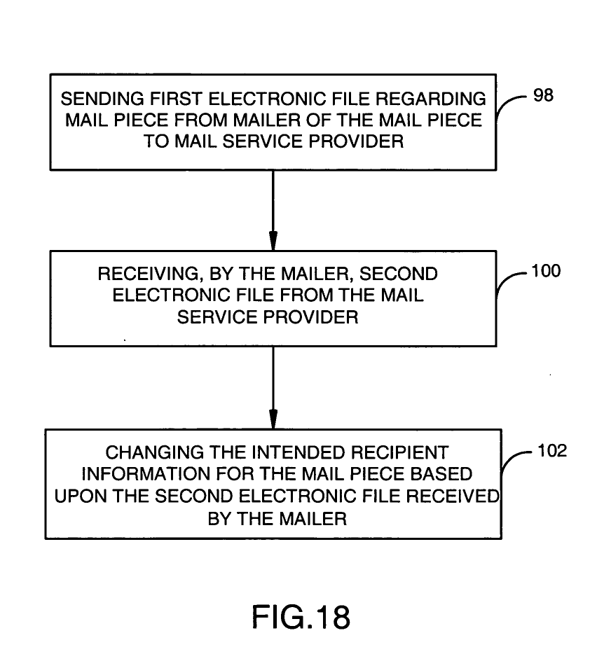

Features of the invention can be used to redirect a mail piece to the same addressee at a new address or redirect a mail piece to a totally different recipient. Referring also to FIG. 18, a method of preparing a mail piece to be mailed by a mailer can comprise sending 98 a first electronic file regarding the mail piece from the mailer of the mail piece to a mail service provider, wherein the first electronic file comprises intended recipient information; receiving 100, by the mailer, a second electronic file from the service provider (such as the mail service provider for example), wherein the second electronic file comprises information from the first electronic file and information from an electronic communication of an intended recipient of the mail piece to the mail service provider; and changing 102 the intended recipient information for the mail piece based upon the second electronic file received by the mailer. In one example, the mail service provider could correct the address on receiving the mail. This can eliminate notifying the mailer of short term address changes of the recipient.

With the invention, based upon feedback from the intended recipient or the service provider before the mail piece is mailed, the mailer can change the address of the mail piece before or after the mail piece is created. This eliminates the need for the mail service provider to place a change of address label on the mail piece after the mail piece is mailed. This can speed up mail delivery and make mail delivery more efficient when an intended recipient moves or if there is a change of address recorded with the mail service provider. With the invention, based upon feedback from the intended recipient or the service provider before the mail piece is mailed, the mailer can change the addressee on the mail piece to a new and different intended recipient, such as when the first intended recipient indicates not to deliver the mail piece.

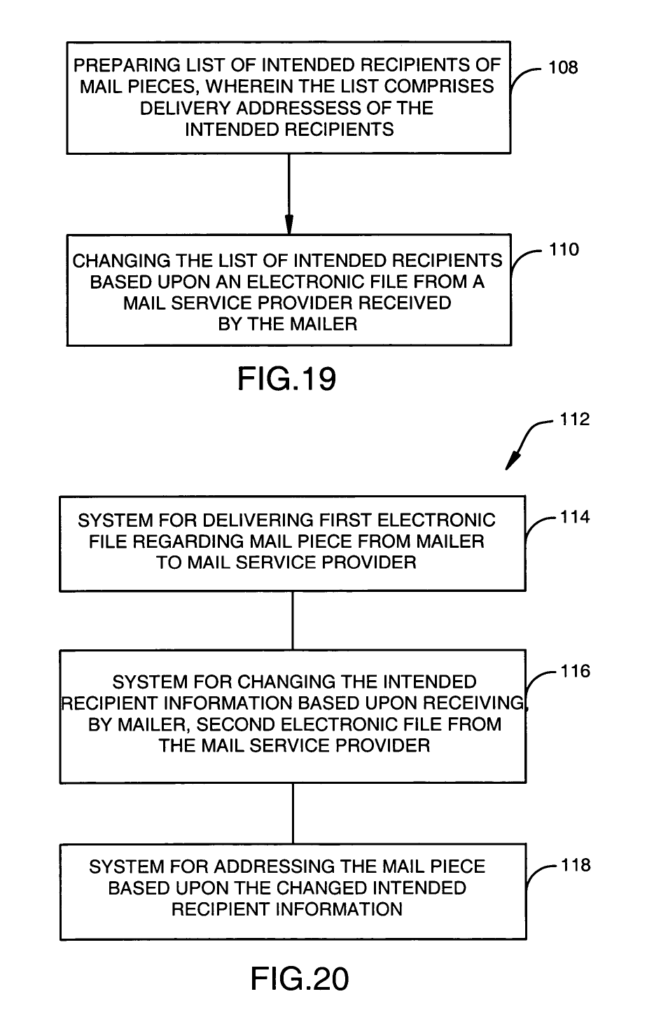

Referring also to FIG. 19, the method can comprise preparing a list of intended recipients of the mail pieces as indicated by block 108; and changing the list of intended recipients based upon an electronic file from a service provider (such as the mail service provider for example) received by the mailer as indicated by block 110. The electronic file from the service provider comprises information from an electronic communication of an intended recipient on the list, and wherein changing the list comprises deleting the intended recipient from the list. The method can comprise preparing 108 a list of intended recipients of the mail pieces, wherein the list comprises delivery addresses of the intended recipients; and changing 110 the list of intended recipients based upon an electronic file from a service provider (such as the mail service provider for example) received by the mailer. The electronic file from the service provider can comprise information from an electronic communication of an intended recipient on the list. Changing the list can comprise changing at least one of the delivery addresses corresponding to the intended recipient on the list.

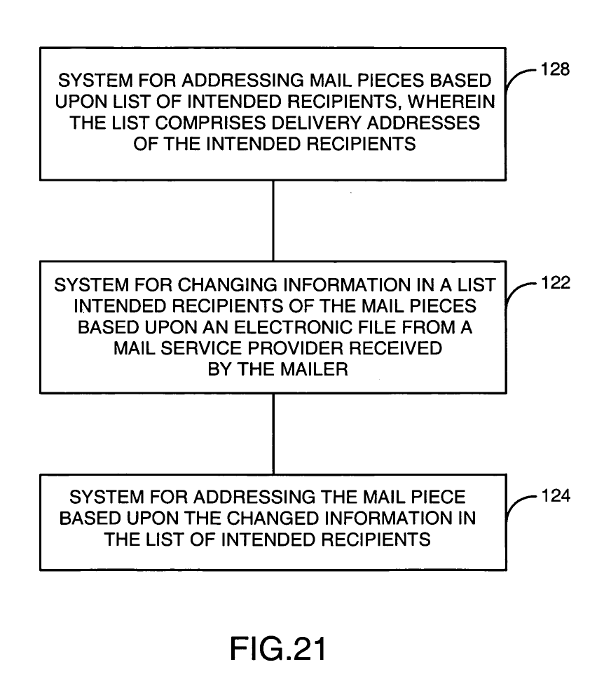

FIGS. 20-21 illustrate redirection systems. Referring to FIG. 20, a system 112 for preparing a mail piece to be mailed by a mailer could be provided comprising a system 114 for delivering a first electronic file regarding the mail piece from the mailer to a mail service provider; a system 116 for changing the intended recipient information based upon receiving, by the mailer, a second electronic file from a service provider (such as the mail service provider for example); and a system 118 for addressing the mail piece based upon the changed intended recipient information. The first electronic file can comprise intended recipient information. The second electronic file can comprise information from the first electronic file and information from an electronic communication of an intended recipient of the mail piece to the service provider.

As seen in FIG. 21, a system for preparing mail pieces to be mailed by a mailer can be provided comprising a system 122 for changing information in a list of intended recipients of the mail pieces based upon an electronic file from a service provider (such as a mail service provider for example) received by the mailer; and a system 124 for addressing the mail pieces based upon the changed information in the list of intended recipients. The electronic file from the service provider can comprise information from an electronic communication of an intended recipient on the list. The information changing system can be adapted to delete the intended recipient from the list.

A system for preparing mail pieces to be mailed by a mailer can be provided comprising a system 128 for addressing mail pieces based upon a list of intended recipients, wherein the list comprises delivery addresses of the intended recipients; and the system 122 for changing the list of intended recipients based upon an electronic file from a service provider received by the mailer. The electronic file from the service provider can comprise information from an electronic communication of an intended recipient on the list. The system for changing the list can be adapted to change at least one of the delivery addresses on the list.

The invention can be used in an embodiment which comprises secure email communications. More specifically, it may be preferred to have a secure communications arrangement between the intended recipient and the service provider. For example, the communication device 30 of the recipient 16 can have a certificate or public/private electronic key for encrypted trusted communication. The system could comprise an electronic mail box for each intended recipient which is only accessible through the service provider (or a sub-contractor of the service provider). It is not limited to these parties. A third party, not a subcontractor to the mail service provider, could provide this service. The service provider can perform the authentication of access. In a non-mail box system, communications would preferably come from the service provider (preferably not from the mailer), so the intended recipient would only need one digital signature or certificate from the service provider to authenticate communications regarding mail pieces from multiple mailers. The functions of the service provider related to information exchange and processing could be performed by a third party. The third party does not necessarily need to be under contract with the mail service provider.

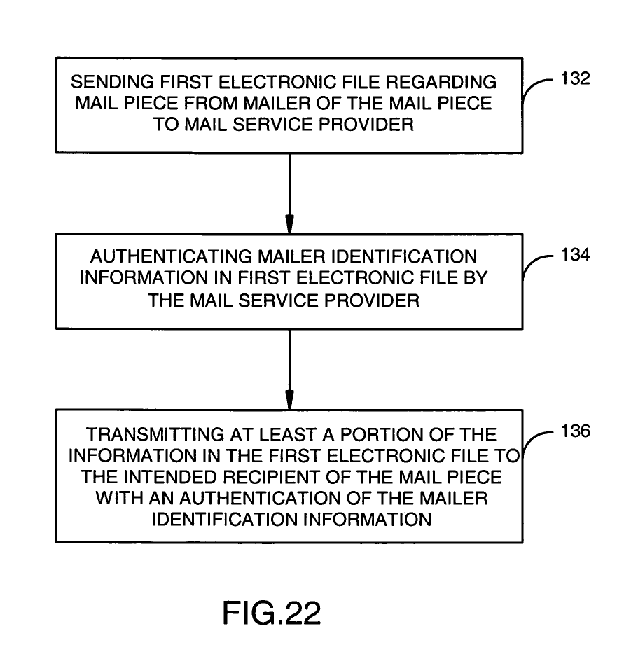

Referring to FIG. 22, a method for notifying an intended recipient of a mail piece regarding the mail piece can be provided comprising sending a first electronic file regarding the mail piece from a mailer of the mail piece to a service provider as indicated by block 132; authenticating 134 the mailer identification information in the first electronic file by the service provider; and transmitting 136 at least a portion of the information in the first electronic file to the intended recipient of the mail piece with an authentication of the mailer identification information. Information in the first electronic file can comprise mailer identification information.

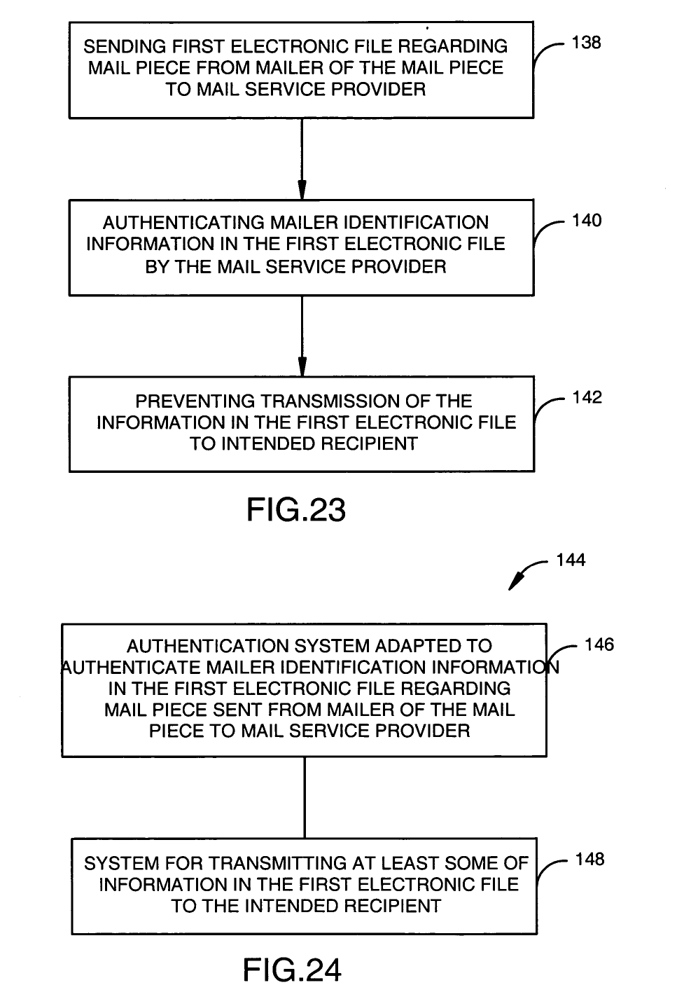

Referring also to FIG. 23, a method for notifying an intended recipient of a mail piece regarding the mail piece can comprise sending a first electronic file regarding the mail piece from a mailer of the mail piece to a service provider as indicated by block 138; authenticating 140 the mailer identification information in the first electronic file by the service provider; and preventing transmission of the information in the first electronic file to the intended recipient unless the service provider authenticates the mailer identification information in the first electronic file as indicated by block 142. Information in the first electronic file can comprise mailer identification information.

As illustrated in FIG. 24, a system 144 for notifying an intended recipient of a mail piece regarding the mail piece can be provided comprising an authentication system 146 adapted to authenticate mailer identification information in a first electronic file regarding the mail piece sent from a mailer of the mail piece to a mail service provider; and a system 148 for transmitting at least some information in the first electronic file to the intended recipient only after the authentication system has authenticated the mailer identification information in the first electronic file.

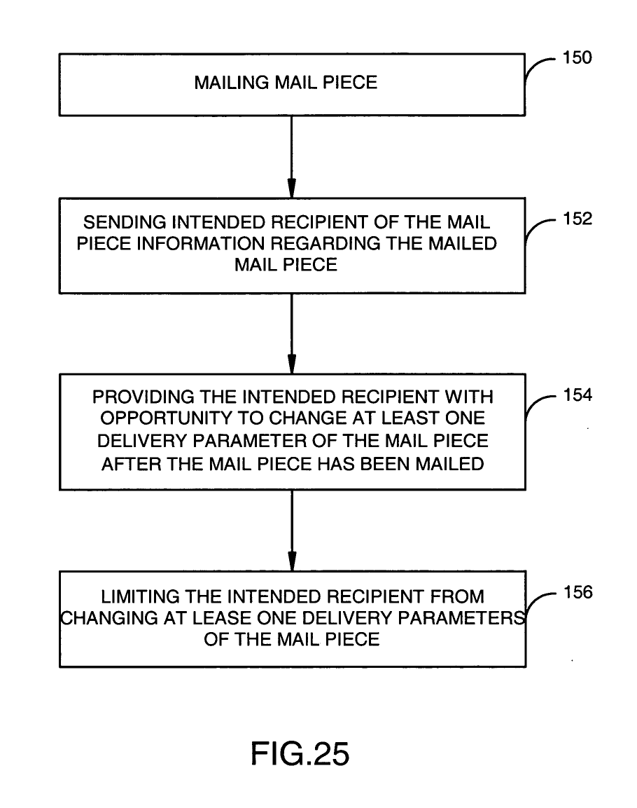

As noted above, a feature of the invention can comprise allowing the intended recipient the opportunity to send the second communication and change at least one delivery parameter of the mail piece. A further feature of the invention is the ability to allow a mailer to apply at least one restriction regarding the intended recipient's delivery parameter changing capability. Referring to FIG. 25, with one method of the invention, a method of changing delivery parameters of a mail piece can be provided comprising mailing the mail piece as indicated by block 150; sending 152 an intended recipient of the mail piece information regarding the mailed mail piece; providing the intended recipient with an opportunity to change at least one of the delivery parameters of the mail piece after the mail piece has been mailed as indicated by block 154; and limiting 156 the intended recipient from changing at least one of the delivery parameters of the mail piece based upon an instruction sent to a mail service provider by a mailer of the mail piece. Thus, even though an intended recipient might be able to change a delivery parameter of a first mail piece, the intended recipient might be prevented from changing a delivery parameter of a second mail piece. For example, if the first mail piece is a check, the system might allow the intended recipient to change the delivery address to a new address, or change the delivery method from first class mail to overnight mail delivery, or have the mail service provider hold the mail piece until picked up by the intended recipient. However, if the second mail piece is a real estate tax bill, the mailer might instruct the service provider to not allow redirection. With the invention, one type of redirection could be a transformation of a check to an electronic payment. This redirection could be performed by the service provider. Redirection of checks to electronic payments by the service provider would be possible with this system because of the trusted relationship between the service provider and mail recipient, and/or between the service provider and the mailer. For example, if the mailer intends to mail a check to the recipient, upon an instruction from the recipient and/or the mailer, the service provider could electronically deposit funds in the recipients' bank account and debit funds from the mailers' bank account. This would eliminate the need for the mailer to mail the check (and perhaps eliminate the need for the mailer to create the check). The service provider could charge the recipient and/or the mailer for this service. This is only one example of redirection when value (such as a check, credit, coupon, etc.) are part of the mail piece.

A method of delivering a mail piece can be provided comprising receiving the mail piece for delivery to a recipient in accordance with a first delivery service level; establishing a cost associated with the first delivery service level; providing an electronic notification to the recipient about the mail piece including information relating to the first delivery service level; receiving a request from the recipient to change the first delivery service level to a second delivery service level; establishing an incremental cost associated with the change to the second delivery service level; and attributing the incremental cost to the recipient. 25. A method as in claim 24 wherein the electronic notification includes information about the mail piece. The mail piece information can include at least some of mailer identity, content and date of deposit. The first and second delivery service levels can include at least one of delivery time, insurance, signature requirement, class of service and tracking. The information in the electronic notification can include first information from a first communication from a mailer to a service provider.

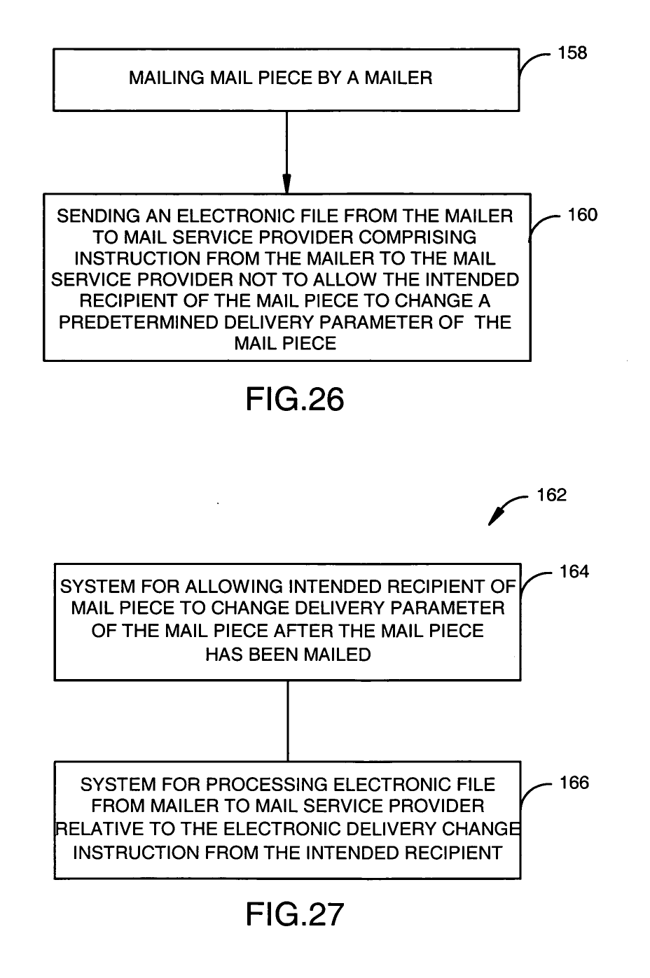

As indicated in FIG. 26, a method of limiting change of delivery parameters of a mail piece can be provided comprising mailing the mail piece by a mailer as indicated by block 158; and sending 160 an electronic file from the mailer to a mail service provider. The electronic file can comprise an instruction from the mailer to the mail service provider not to allow the intended recipient of the mail piece to change a predetermined delivery parameter of the mail piece.

Referring also to FIG. 27, a system 162 for limiting change of delivery parameters of a mail piece can be provided comprising a system 164 for allowing an intended recipient of the mail piece to change at least one of the delivery parameters of the mail piece after the mail piece has been mailed by sending an electronic delivery change instruction to a mail delivery provider; and a system 166 for processing an electronic file from the mailer to the mail service provider relative to the electronic delivery change instruction from the intended recipient. The electronic file can comprise an instruction from the mailer to the mail service provider to allow or not allow the intended recipient of the mail piece to change a predetermined one of the delivery parameters of the mail piece.

In conventional mailing methods, the mailer generates and mails a significant number of mail pieces to recipients. Sometimes the recipients either discarded the mail pieces or would rather receive the contents of the mail pieces in a more cost effective electronic form. This problem is solved by the invention in that the service provider (e.g., the postal carrier system) can notify intended recipients before processing of a respective mail piece starts. This notification enables a recipient to cancel delivery of a mail piece, or option to have electronic delivery of the mail piece contents which were to be mailed to the recipient; among other possible options. With regard to conventional mail piece track and tracing methods, the conventional methods relied on optical scanning of a mail piece after the mail piece enters the processing mail piece stream. The present invention does not relied on optical scanning of a mail piece after the mail piece enters the processing mail piece stream. However, in cases where mail is accepted by the mail service provider for re-addressing a mail piece to a new addressee or new address, or deleting the mail piece from the mailstream, optical scanning can be used. Thus, redirection of the mail piece may occur after the mail has been created and introduced into the mailstream.

By providing an electronic mail manifest file (e.g., a MAIL.DAT® file) from a mailer to a postal carrier such as the USPS, the postal carrier can process the information contained in the manifested file preferably before any processing (e.g., scanning) is performed on the mail pieces. This enables the postal carrier to contact intended mail piece recipients and provide them with alternative options regarding delivery of the mail pieces before processing of the mail piece commences in the postal carrier system. This enables significant cost savings to both the mailer and postal carrier system while providing the mail piece recipient with desired mail piece delivery. Some of these options can include:
providing a URL to a recipient relating to the subject matter of a mail piece to be sent;
enabling a recipient to view a URL to determine if the recipient wants physical delivery of the mail piece;
the recipient indicating to a mailer that physical delivery is no longer desired, but electronic delivery is desired;
the recipient prescribing that electronic delivery is conducted via a recipient public email address or via a secure private email address that is known only to the postal carrier;
providing in a URL incentives for a recipient to continue to receive either physical or electronic mail piece delivery from a mailer;
providing for forwarding of mail pieces without requiring any scanning of the mail piece;
creating a web page listing mail pieces that are scheduled to be delivered to a subscribing recipient;
enable a recipient to selectively forward or cancel delivery of individual mail pieces listed in the mail piece manifest secure web page;
allowing canceled-delivery mail pieces to be recycled by either the postal carrier or mailer to a new addressee (e.g., via re-labeling of the addressee information on the mail pieces);
allowing the mailer to automatically update a recipient delivery preference based upon past preferences indicated to the postal carrier;
delivery of a mail piece scheduled for delivery can be upgrade for expedited delivery;
processing of an electronic mailing manifest file (e.g., MAIL.DAT® file) can occur in a postal carrier before the postal carrier receives the actual physical mail pieces; enabling the mailer to only generate a portion of the physical mail pieces based upon recipient preferences indicated to the postal carrier or mailer (such as via a URL for example);
the postal carrier providing a secure email system between the postal carrier and a recipient wherein each electronic mail piece provided to a recipient has electronic “fingerprints”; which fingerprints identify who the mailer is amongst other items mitigating phishing schemes (e.g., PAYPAL, banking and credit card fraud) and email spamming; and
an aforesaid secure email system concealing the recipient's email address from the mailer mitigating spamming by the mailer or sharing of the recipient's email address.

The invention can be used to allow mailers to send “virtual mail” to a postal carrier, that forwards mail electronically to recipients. This can be done without revealing the recipients' email addresses to the mailer. Use of a “virtual” mailing could comprise, for example, a mailer providing the service provider with an electronic file 22 having 100,000 names and addresses of intended recipients before the mail pieces are generated. The service provider could then notify the mailer that 12,000 of the intended recipients do not want the mail pieces delivered. In response to this notification, the mailer could then select to generate and mail only 88,000 mail pieces to the other 88,000 intended recipients. This would eliminate the costs associated with generating and mailing 12,000 mail pieces. This is an example of partial virtual mailing. As an alternate example, the service provider could deliver the information in the mail pieces intended to be generated electronically to 33,000 of the 88,000 who want electronic delivery only, the mailer could generate and mail the other 55,000 of the 88,000 the mail pieces, and the mailer could send different mail pieces to the 12,000. There could also be a total virtual mailing wherein no actual mail pieces are mailed by the mailer. Instead, information from the mailer is delivered and/or filtered by the service provider or mail service provider entirely in electronic form. For example, the USPS could function as the service provider with the intended recipient, therefore, only having to have a “single” account with the USPS to establish all virtual mail filter setting. In another exemplary embodiment, the mailer could send the service provider the address list, and the USPS could deliver notifications to the intended recipients, such as by email for example. There will be those intended recipients that pick up the email notification and click through to a content website and receive the message. There will be those intended recipients that don't click through, and the mailer could settle with the fact that those recipients will not read the message. This is different from simply redirecting the mail to email. These are only some examples of ways in which the invention could be used. A postal carrier system can be provided with a secure web page for a subscribing mail piece recipient listing mail pieces that are scheduled to be delivered to a subscribing recipient based upon an electronic mail manifest file (e.g., MAIL.DAT®) received by the postal carrier system. The subscribing recipient could then be enabled to selectively process each mail piece in the postal carrier system (e.g., mail piece forwarding, cancellation, expedited delivery, or opting for electronic mail piece delivery) without requiring each aforesaid mail piece to be first processed in the postal carrier system (i.e., eliminating optical mail piece scanning by the postal carrier system).

By providing an electronic mail manifest file (e.g., a MAIL.DAT® file) from a mailer to a postal carrier (such as the USPS for example), the carrier can process the information contained in the manifested file preferably before any processing (e.g., scanning) performed on the mail pieces corresponding to the aforesaid electronic manifested mailing file. This processing can prepare the postal carrier for the physical mail pieces from the mailer.

If an intended recipient requests special processing of delivery, such as accelerating delivery, a system should be provided for paying the mail service provider; either by the mailer or the intended recipient. If intended recipient control allows redirection or canceling of delivery, a system should be provided for the mailer to instruct the mail service provider not to allow the intended recipient to cancel or redirect certain types of mail pieces. This could be an instruction in a field of the MAIL.DAT® file, or some other instruction communication means. For mail pieces to be redirected (recycled to a new addressee) by the mail service provider, a system for providing a list of potential new addressees from the mailer to the mail service provider should be provided.

Although the invention has been described with the use of a MAIL.DAT® file in some examples, the use of a MAIL.DAT® file with the invention is different from conventional uses of MAIL.DAT® files. This new use of MAIL.DAT® files is unique and provides advantages and methods as noted from the examples described above. It is noted that the invention is not limited to the use of a MAIL.DAT® file. Other electronic files having similar features and characteristics may be used as well.

It should be noted that the functions of processing mail, and processing information performed by the mail service provider, could be split and performed by more than one entity. For example, at least one third party could pre-notify the recipient, gather information from the recipient and feed back that information to the mailer. In this scenario the mail service provider would simply process the mail.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A method for changing a delivery parameter of a mail piece intended to be delivered to an intended recipient, the method comprising:
receiving a first electronic file from a mailer regarding the mail piece;
sending a first electronic communication to the intended recipient based upon the first electronic file;
receiving a second electronic communication based upon the first electronic communication; and
wherein at least one of the delivery parameters of the mail piece are changed based upon the second electronic communication.

2. A method as in claim 1 wherein the delivery parameter comprises a special processing delivery parameter, and changing the delivery parameter of the mail piece comprises changing the special processing delivery parameter of the mail piece.

3. A method as in claim 1 wherein the service provider comprises a mail service provider.

4. A method as in claim 1 wherein the delivery parameter comprises speed of delivery of the mail piece.

5. A method as in claim 1 wherein changing the delivery parameter of the mail piece comprises not delivering the mail piece.

6. A method as in claim 1 wherein changing the delivery parameter of the mail piece comprises re-directing the mail piece.

7. A method as in claim 1 wherein changing the delivery parameter of the mail piece comprises changing the address of the mail piece.

8. A method as in claim 1 further comprising viewing at least a portion of contents of the mail piece electronically by the intended recipient.

9. A method as in claim 1 wherein the first electronic communication comprises an email.

10. A method as in claim 1 wherein the email comprises a URL link.

11. A method as in claim 1 wherein the first electronic communication comprises information regarding the mail piece.

12. A method as in claim 11 wherein the second electronic communication comprises at least some information from the first electronic communication.

13. A method as in claim 11 wherein the first electronic file comprises intended recipient information, wherein a second electronic file from the service provider to the mailer comprises at least some information from the first electronic file and information from the second electronic communication, and the method further comprises:
changing the intended recipient information for the mail piece based upon the second electronic file received by the mailer.

14. A method of preparing mail pieces to be mailed by a mailer, the method comprising:
preparing a list of intended recipients of the mail pieces; and
changing the list of intended recipients based upon an electronic file from a service provider received by the mailer, wherein the electronic file from the service provider comprises information from an electronic communication of an intended recipient on the list, and wherein changing the list comprises deleting the intended recipient from the list or changing a delivery address corresponding to the intended recipient on the list.

15. A system for changing a delivery parameter of a mail piece intended to be delivered to an intended recipient, the system comprising:
a system for receiving a first electronic file from a mailer regarding the mail piece;
a system for sending a first electronic communication to the intended recipient regarding the mail piece based upon the first electronic file;
a system for receiving a second electronic communication from the intended recipient based upon the first electronic communication; and
a system for changing the delivery parameter of the mail piece based upon the second electronic communication.

16. A system for changing a delivery parameter of a mail piece as in claim 15 wherein the system for changing a delivery parameter is adapted to change a special processing delivery parameter of the mail piece.

17. A system for changing a delivery parameter of a mail piece as in claim 16 wherein the special processing delivery parameter comprises speed of delivery of the mail piece.

18. A system for changing a delivery parameter of a mail piece as in claim 15 wherein the system for changing the delivery parameter of the mail piece based upon the second electronic communication is adapted to stop delivery of the mail piece to the intended recipient.

19. A system for changing a delivery parameter of a mail piece as in claim 15 wherein the system for changing the delivery parameter of the mail piece based upon the second electronic communication is adapted to re-direct the mail piece.

20. A system for changing a delivery parameter of a mail piece as in claim 15 wherein the system for changing the delivery parameter of the mail piece based upon the second electronic communication is adapted to re-address the mail piece.

21. A system for changing a delivery parameter of a mail piece as in claim 15 wherein the first electronic file comprises intended recipient information, and wherein the second electronic file comprises at least some information from the first electronic file and information from the second electronic communication; and further comprising a system for addressing the mail piece based upon the changed intended recipient information.

22. A system for preparing mail pieces to be mailed by a mailer, the system comprising:
a system for changing information in a list of intended recipients of the mail pieces based upon an electronic file from a service provider received by the mailer, wherein the electronic file from the service provider comprises information from an electronic communication of an intended recipient on the list, and wherein the information changing system is adapted to delete the intended recipient from the list; and
a system for addressing the mail pieces based upon the changed information in the list of intended recipients.

23. A method of delivering a mail piece, the method comprising the steps of:
receiving the mail piece for delivery to a recipient in accordance with a first delivery service level;
establishing a cost associated with the first delivery service level;
providing an electronic notification to the recipient about the mail piece including information relating to the first delivery service level;
receiving a request from the recipient to change the first delivery service level to a second delivery service level;
establishing an incremental cost associated with the change to the second delivery service level; and
attributing the incremental cost to the recipient.

24. A method as in claim 23 wherein the electronic notification includes information about the mail piece.

25. A method as in claim 24 wherein the mail piece information includes at least some of mailer identity, content and date of deposit.

26. A method as in claim 23 wherein the first and second delivery service levels include at least one of delivery time, insurance, signature requirement, class of service and tracking.

27. A method as in claim 23 wherein the information in the electronic notification includes first information from a first communication from a mailer to a service provider.
